(19) United States
(12) Patent Application Publication
(10) Pub. No.: US 2008/0259006 A1
(43) Pub. Date: Oct. 23, 2008

(54) Driving Circuit of Organic Light Emitting Diode Display Panel and Precharging Method Using the Same

(75) Inventors: Seen Suk Kang, Seoul (KR); Seong Ik Jeong, Seoul (KR)

Correspondence Address: CANTOR COLBURN, LLP, 20 Church Street, 22nd Floor, Hartford, CT, 06103, US

(73) Assignee: SYNCOAM CO., LTD, Seongnam City (KR)

(21) Appl. No.: 12/089,505

(22) PCT Filed: Sep. 20, 2006
(86) PCT No.: PCT/KR2006/003725

§ 371 Date: Apr. 7, 2008

(30) Foreign Application Priority Data
Oct. 18, 2005 (KR) 10-2005-0097927

(51) Int. Cl. G09G 3/30

(52) U.S. Cl. 345/76; 345/82; 345/214

(57) ABSTRACT

There is provided a driving circuit in which a voltage level can reach a full Vcc level when precharging and a precharging method using the same although a parasitic capacitance of an organic light emitting diode (OLED) panel increases.

A driving circuit of an OLED panel includes according to the present invention: a precharge channel which is applied with Vcc voltage and operates when precharging; a discharge channel which is connected to the precharge channel in series and is connected to ground (GND) and is turned off when precharging; and a time shift circuit which is connected to the precharge channel and controls a voltage level according to a time setting.

According to the present invention, a precharge voltage level can reach a full Vcc level according to a time setting although a parasitic capacitance of an OLED panel increases. Therefore, a driving circuit can be simply and easily implemented.

### TECHNICAL FIELD

The present invention relates to an organic light emitting diode (OLED), and more particularly, to a driving circuit of an OLED.

### BACKGROUND ART

As an image display apparatus for TVs, computers, or mobile phones, a liquid crystal display (LCD) has been widely used. However, since the LCD needs a backlight, there are problems in that, the LCD is heavy-weight and thick, and a response speed thereof is slow. As a next generation image display apparatus replacing the LCD, an organic light emitting diode (OLED) display panel has been proposed. The OLED panel includes an organic thin film having an very thin thickness less than 0.1□.

When a current is passed through the organic thin film, an electron and a hole recombine near the interface between an electron transport layer and a hole transport layer to emit light. The light emission has a very fast response speed less than hundreds of nanoseconds.

The OLED is constructed with two electrodes: an anode and a cathode, similarly to an inorganic light emitting diode. Due to voltage and current differences between individual OLEDs constituting the panel, current can be driven.

FIG. 1 is a view showing a current driving mode of a conventional OLED to explain a precharging method used in a driving integrated circuit (IC) of the OLED panel.

In the precharging method using a current mirror, a current is set to be flown according to a needed voltage level.

FIG. 2 is a graph showing a voltage level which is adjusted by a current setting.

The current precharging method in which a voltage level is adjusted by a current setting shown in FIGS. 1 and 2 has a problem in that, when a panel parasitic capacitance increases, the voltage level cannot reach a needed level within a pre-determined time. That is, a full Vcc level is difficult to reach.

### DISCLOSURE OF INVENTION

### Technical Problem

In order to solve the aforementioned problems, an object of the present invention is to provide a driving circuit in which a voltage level can reach a full Vcc level when precharging and a precharging method using the same although a parasitic capacitance of an organic light emitting diode (OLED) panel increases.

### Technical Solution

According to an aspect of the present invention, there is provided a driving circuit using a precharging method for driving an organic light emitting diode (OLED) panel, the driving circuit including: a precharge channel which is applied with Vcc voltage and operates when precharging; a discharge channel which is connected to the precharge channel in series and is connected to ground (GND) and is turned off when precharging; and a time shift circuit which is connected to the precharge channel and controls a voltage level according to a time setting.

According to another aspect of the present invention, there is provided a precharging method used in a driving circuit for driving an OLED panel, the precharging method including: setting time in a time shift circuit which is connected to a precharge channel constructed with a metal oxide semiconductor (MOS) transistor; and controlling a voltage level of the precharge channel by driving the time shift circuit in which time is set.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a current driving mode of a conventional organic light emitting diode (OLED) to explain a precharging method used in a driving integrated circuit (IC) of the OLED panel.

FIG. 2 is a graph showing a voltage level which is adjusted by a current setting;

FIG. 3 is a view showing a driving circuit of an OLED panel according to an embodiment of the present invention; and

FIG. 4 is a graph showing a change in voltage level according to a time setting.

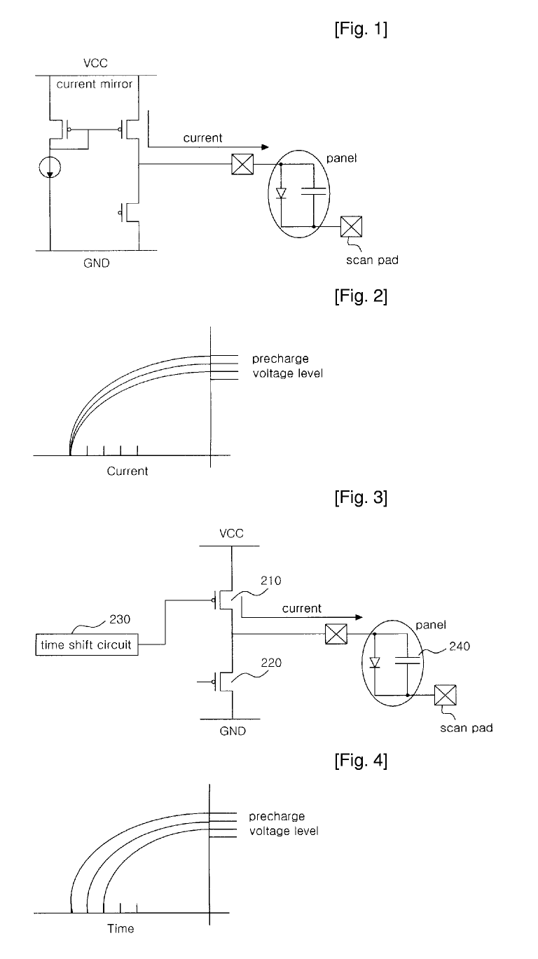

### BEST MODE FOR CARRYING OUT THE INVENTION

Hereinafter, the present will be described in detail with reference to accompanying drawings.

FIG. 3 is a view showing a driving circuit of an organic light emitting diode (OLED) panel to explain a precharging method used in a driving integrated circuit (IC) of the OLED panel according to an embodiment of the present invention.

A precharge channel 210 constructed with a positive-channel metal oxide semi-conductor (PMOS) transistor and a discharge channel 220 constructed with a negative-channel metal oxide semiconductor (NMOS) are connected in series. The precharge channel 210 is applied with a Vcc voltage. The discharge channel 220 is connected to ground (GND).

The precharge channel 210 is connected to a time shift circuit 230 in which a voltage level is controlled by a time setting. The time shift circuit 230 is set so as to change a precharge voltage level according to the time setting.

The discharge channel 220 is turned off when precharging.

Therefore, in the driving circuit of the OLED panel according to the present invention, the precharge voltage level can reach a full Vcc voltage although a parasitic capacitance of the OLED panel increases.

FIG. 4 is a graph showing a change in voltage level according to a time setting.

In the time shift circuit 230, the precharge voltage level of the precharge channel 210 changes according to the time setting. More specifically, in the time shift circuit 230, time is set to be long, the precharge voltage level of the precharge channel 210 increases.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

According to the present invention, a precharge voltage level can reach a full Vcc level according to a time setting although a parasitic capacitance of an organic light emitting diode (OLED) panel increases. Therefore, a driving circuit can be simply and easily implemented.

1. A driving circuit using a precharging method for driving an OLED (organic light emitting diode) panel, the driving circuit comprising:
a precharge channel which is applied with Vcc voltage and operates when precharging;
a discharge channel which is connected to the precharge channel in series and is connected to GND (ground) and is turned off when precharging; and
a time shift circuit which is connected to the precharge channel and controls a voltage level according to a time setting.

2. The driving circuit according to claim 1, wherein the precharge channel is constructed with a MOS (metal oxide semiconductor) transistor.

3. A precharging method used in a driving circuit for driving an OLED panel, the precharging method comprising:
setting time in a time shift circuit which is connected to a precharge channel constructed with a MOS transistor; and
controlling a voltage level of the precharge channel by driving the time shift circuit in which time is set.
